(19) United States
(12) Patent Application Publication
(10) Pub. No.: US 2003/0158937 A1
(43) Pub. Date: Aug. 21, 2003

(54) Methods and systems for using distributed business data using observation technology to avoid the need to integrate servers and clients

(76) Inventors: Sumer Singh Johal, Walnut Creek, CA (US); Sanjay Dayal, Oakland, CA (US); Jeffrey Bruce Klein, Berkeley, CA (US); Julian Mark James Brookes, San Francisco, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/081,898

(22) Filed: Feb. 20, 2002

(51) Int. Cl. G06F 15/173

(52) U.S. Cl. 709/224; 709/202

(57) ABSTRACT

Using observation agents, listening agents and notifying agents, a method and system provides for using distributed business data without the need to integrate the distributed data. In addition, the notification can occur in “real time” without batch processing.

### FIELD OF THE INVENTION

The present invention relates to information systems (e.g., evolving enterprise systems), and more particularly to data management, data analysis, knowledge creation, and decision support.

### BACKGROUND OF THE INVENTION

The ability to act quickly and decisively in today's increasingly competitive marketplace is critical to the success of any organization. As a basis for intelligent decision-making, data is an organization's biggest potential asset; however, to realize its potential, businesses must be able to gather and reconcile data in different formats and from various sources (“data management”); transform that data into knowledge via intelligent analysis (“knowledge creation”); and use that knowledge, in as close to “real time” as possible, as the basis for modifying and optimizing business operations (“decision support”).

Current approaches to data management, analysis, knowledge creation, and decision support focus on the data warehouse and related technologies. Data warehouses, relational databases, and data marts provide the central location where a reconciled version of data extracted from a wide variety of operational systems may be stored. A data warehouse is an informational database that stores and often replicates shareable data from one or more operational databases of record; it supports informational processing by providing a foundation of integrated, enterprise-wide, non-volatile historical data. A data mart may be considered a type of data warehouse that focuses on a particular business segment.

The challenge of leveraging data via knowledge creation into intelligent business decision-making is formidable and presents difficulties at every step of the process. Current technologies fail to overcome these difficulties for reasons described below.

Referring to FIG. 1 there is shown a schematic diagram depicting a representative enterprise information system of the prior art. Customer 10's and client 1's interaction data sources are a heterogeneous combination of touchpoint-specific, type-specific, platform-specific entities, distributed across the client's enterprise (and usually also geographically). This environment is characterized by:

Multiple touchpoints (Branch Office 3, Call Center 4, Web Site 5, ATM Machine 6, 9), for both customer information 11 and transactional interaction 12a, 12b

The various touchpoints are accessed via various mechanisms, both human and machine-based, e.g., walking to branch 3; using the telephone 7 to access call center 4; or using PC 8 to access the Internet

Each touchpoint is a data source of potentially various types (Relational Database 12b, flat file 12a, Application 12, etc.)

Each data source type can reside on a particular platform typically a server computer such as IBM DB2/Unix, SQLServer/NT, etc.

The data from multiple touch points (3,4,5,6) are communicated via a communication network (intranet or internet) 13 to the central information-processing center 2, where it is stored and possibly “mined” to glean any relevant intelligence, which is then fed to the client's headquarters 1.

Customer interaction data is interactive and “fall duplex,” meaning that both informational (web content, promotions, etc) and transactional data (account information, etc.) are put into—and in other cases retrieved from—the data sources. However, significantly more data is put into the systems than is retrieved from them because the act of retrieval is itself recorded and stored. In effect, from a data collection and recording perspective, this interaction is a continuously growing “collection” of data.

Once the data is stored in the Central Processing Center 2, businesses want to benefit from any intelligence derived from the interaction, so a whole host of applications emerge to facilitate transformation of this continuously collected data into useful business intelligence, usually in a batch mode (nightly, monthly, etc.). This process is loosely termed “mining,” hence the applications are typically called “data mining” applications. The basic function of these applications is to “extract” intelligence from past data. This extraction process is represented as an arrow in FIG. 1 from Center 2 to headquarter 1.

Once mined, the business intelligence uses Business Units 1a and 1b to create or modify business rules that form the basis of various decisions typically distributed across several functional areas of the financial enterprise. This process of “pushing” out the intelligence to the various operations decision points is known as “operationalizing” intelligence. Several applications operate in this context, all “using” this intelligence to positively “impact” the interacting customers and possibly increase the value of future interactions. This is also shown in thick arrows in FIG. 1 flowing outward from the headquarter 1.

There are a number of drawbacks of the foregoing prior art as identified below

### Data Management

The first difficulty has to do with data management. The quantity of data available to organizations is increasing all the time and originates in diverse, widely distributed, often incompatible—and sometimes unknown—enterprise information sources. As a result, collecting, transforming, integrating, and reconciling all this data (i.e. getting it to the point where an enterprise can even begin to make sense of it) is a cumbersome, time-consuming, and extremely expensive process.

Under the traditional approach, data is transferred into data warehouses and thence to data marts for decision support systems to work with. This presents a few immediate problems:

As it is not known what data will subsequently be needed, almost all data generated must be warehoused, causing a lot of logistical overhead in storage, backup, and availability of the data assets

The problem of warehousing from diverse data sources presents a formidable integration challenge

Once the data warehousing is complete, a change or evolution in an application's data needs to be re-warehoused for the additional information, so the process never finishes

Worst of all, most of the steps towards making even this warehoused data available remain unsolved (though some progress has been made in “right transformation”—i.e., the reorganization, reformatting, and aggregation of some data).

### Data Analysis/Knowledge Creation

Current approaches to data analysis have been developed to retrieve selected information from data warehouses. One such is known as an on-line analytical processing system (OLAP). In general, OLAP systems analyze the data from a number of different perspectives and generate reports based on complex analyses against large input data sets.

Problems with this method include the following:

Analytical Tools are Overwhelmed by Quantity of Data

The analytical tools designed to effect analysis are overwhelmed by the sheer quantity of data they have to work with. Further, because they fail to discriminate adequately between relevant and irrelevant data, these technologies are not especially effective at converting it quickly and intelligently into knowledge. (And as the quantity of data collected increases, as it inevitably does, this problem grows).

Method is Not Suited to Exploratory, Non-scheduled Analysis

In order to do “exploratory,” non-scheduled, ad hoc analysis (i.e. the kind that creates new knowledge), the user typically engages in a process that involves a step-by-step exploration. At any given step in this process, only a few next steps may be known in advance in terms of the type, kind, format, and detail of the data required to do the analysis at that step. Thus the entire path is usually not fully charted, nor is the entire set of the data required (and its associated parameters like format, depth, type, etc.) clear. So, the typical process of exploratory data analysis constantly engages the data source in “ad-hoc” queries that get refined as the investigator explores the problem. These “ad-hoc” queries create massive overhead on the system (both organizational structure and the IT systems) and, due to resource constraints, there are delays at every step of the way—delays mostly associated with systems, people, organizations, and their complex inter-dynamics, and having nothing to do with the investigator or the problem at hand. Hence the creation of new knowledge is greatly inhibited. Intuition (usually the starting point of this exploration) is typically diluted if not entirely lost, and the cost implications for the business enterprise are extremely large.

### Decision Support

Decision Support Systems (DSS) technology allows for the use of a “decision tree”-based analysis whereby decisions, uncertainties, events (both known and unknown), risks, and rewards can be captured in a causal, related network to assess the impact on decision making of any change in policy. Such systems range from simple diagrams to vast parallel computational systems. However, the fundamental element missing in DSS technology today is the link or relationships with the “operational” systems. These relationships would ideally facilitate a “fully duplex” communication flow i.e., decision making (via DSS) can get accurate inputs (rather than estimates) from operational systems and conversely, the outputs of DSS can be input directives/objectives of operational systems, rather than just rough manual guidelines to management. This discussion includes feedback of customer responses to offers made to them via such decisions. This feedback, in this “full-duplex” analogy can be used to refine both the rules and the input parameters of the DSS for the next iteration of decisioning—which could be as soon as the next customer in the queue.

Problems with this method include the following:

Batch Processing

Since it is impossible to move such large volumes of data in near-real time, the approach has been to run batch processes or dedicated data extraction utilities during off-peak hours, the frequency of these processes depending on how urgently the data is needed. This may work for applications where the analytical queries are ad hoc, but for very targeted analytics it works much less well.

Functional Disjunction Between Knowledge Creation and Decision Support

The analysis function (knowledge creation) is not linked at the system level to business operations. Typically, one team conducts analysis and produces reports; another team takes delivery of these reports and makes operation and strategic decisions based on them. There is thus a functional disconnect between knowledge creation and decision-making. This makes coordination difficult and increases the time lag between knowledge discovery and operational decisions—highly problematic in cases where analysis indicates a need for speedy action. A better approach would be one where knowledge creation is linked seamlessly to decision making at the level of the information system via business rules.

Decision Support is Not Optimized Because Not All Available Data is Used

Current information management systems can take years to implement and are in fact never completed. This flows from the basic fact that all servers must connect with all clients on a one-to-one basis; this requirement means that not all clients are connected to the servers that could supply them with important, if not essential, information. Even if new servers coming online are eventually connected to clients, it is likely that this will not be done in a timely manner. The result is that business decisions are routinely based on incomplete or anachronistic data.

Architectural Shortcomings

No Scope for Complex Feedback Loops

A further shortcoming is that this traditional architecture is built upon the assumption that the triggering response to change the state of the system originates outside the system. However, as enterprise applications evolve in sophistication there arises a need for an architecture that can accommodate complex feedback loops (rather than a simple linear flow of information) in the information and knowledge dissemination chain.

Unidirectional Tools are Mismatched with Bi-directional Data Flow

Attempts at bridging this bidirectional flow of information and knowledge fall short because they rely on essentially unidirectional technologies for data extraction, namely, Data Warehousing, OLAP, and Decision Support System (DSS)-type technologies. This basic conceptual architectural misfit makes the architecture brittle and severely restricts pro-activity and adaptability—essential attributes of next-generation enterprise systems, which will have to adapt to changing intelligence needs.

These are the main drawbacks with current data management and knowledge creation systems. Finally, although software agents are well known in the art, they have not been used as agents in an evolving or changing enterprise system to observe, notify and filter changes or observations to the various underlying databases.

### SUMMARY OF THE INVENTION

An object of the invention is to overcome these and other drawbacks in existing systems.

The present invention optimizes the performance of information systems by enabling enterprises to use all available data without having to aggregate and analyze it, thus improving the quality and timeliness of knowledge, reducing overhead, and closing the gap between knowledge creation and decision support.

The present invention is an agent-based “observation management platform.” This platform provides a technology infrastructure to rapidly and proactively integrate enterprise data (in the form of “observations”) from diverse, widely distributed information systems within and across an enterprise and its supply chain partners to sophisticated back-end applications to derive relevant business intelligence. This marks a decisive break with the traditional approach to information management, which is driven by data warehousing and subsequent analytics and is thus essentially reactive and plagued by the redundancy and overhead problems described in Background to the Invention.

Note that in the following, an observation is defined as an abstract event tied to a change in enterprise information chain. An observation has a life cycle, which is defined and maintained by the observation management system. Further, an observation can be a composite of other observations. A simple example of an observation is a change in Account Balance of a particular bank customer. The observation generated as a result of such an event will constitute of the following major entities:

The old and new values of the Account balance for the customer

The time at which the observation was recorded

The time for which the observation is valid

The access rights for the observation

A key novelty of this approach is that it provides the ability rapidly to deploy observations with minimal intrusion on the existing applications for seamless dynamic integration.

The proposed platform provides a means to create, catalog, discover, deliver and manage the observations, just as data is managed by database management systems (DBMS). Individual observations in turn can serve as the building blocks of composite observations triggered by the events that affect them.

The primary objective of the invention is to ease the integration of observing data sources in a coherent manner by providing rapid deployment of observation agents and life-cycle management of observations in a declarative paradigm (a non-procedural, “no-programming-required” paradigm; SQL is an example of a declarative paradigm for data management. The SQL client does not know—or care—how the data is stored, or what its address or location is, or what the database's file structure is; it simply creates and uses data). The platform also provides an observation rules-based technology to filter, transform and compose these observations, to provide only relevant knowledge to consuming applications. These rules can be manually or automatically generated depending on the complexity and automation needs of the application.

The observation management platform will provide the basis for a new class of adaptive enterprise applications based on the observation technology; these applications will rely on enterprise observation integration for just-in-time and correct contextual information for the analytics at hand, rather than on large warehouses. The platform also provides a rules-based observation technology to filter, transform, and compose these observations, and to provide relevant knowledge to the consuming applications.

(It is important to note that the present invention is not “middleware”—a layer of software between network and applications; rather, it leverages middleware. Nor is the present invention a database management system (DBMS); rather, it uses DBMS. Nor does it involve integration; rather, it observes data at source.) This can be thought of as analogous to a macro program that operates on top of an existing data management a application program.

### BRIEF DESCRIPTION OF THE DRAWINGS

FIG. 1 is a flow diagram showing a representative enterprise information system of the prior art.

FIG. 2 is a generalized flow diagram showing the present invention.

FIG. 3 is a flow diagram showing the present invention as used in an enterprise information system of the prior art.

FIG. 4 is a detailed diagram of the “observation administration station” shown in FIG. 3.

FIG. 5 is a flow diagram representing the use of the invention in an enterprise information system (of the type shown in FIG. 1)

FIG. 6a is a screen shot showing the user interface for the Observation Agent Console as it is used to create observations

FIG. 6b is a screen shot showing the user interface for the Observation Agent Console as it is used to configure observations through selection of columns.

FIG. 7a is a screen shot showing the user interface for the Observation Agent Console as it is used to edit observations

FIG. 7b is a screen shot showing the user interface for the Observation Agent Console as it is used to edit observations

FIG. 8 is a screen shot showing the user interface for the Observation Management Console as it is used to monitor the status of an observation

### DESCRIPTION OF PREFERRED EMBODIMENTS

According to one embodiment of the present invention, a system is provided for the leveraging of business data from one or more of a plurality of data sources via an observation management platform. The present invention allows enterprise systems to derive knowledge from data and automate decisions based on knowledge without having to aggregate and integrate data in the conventional way.

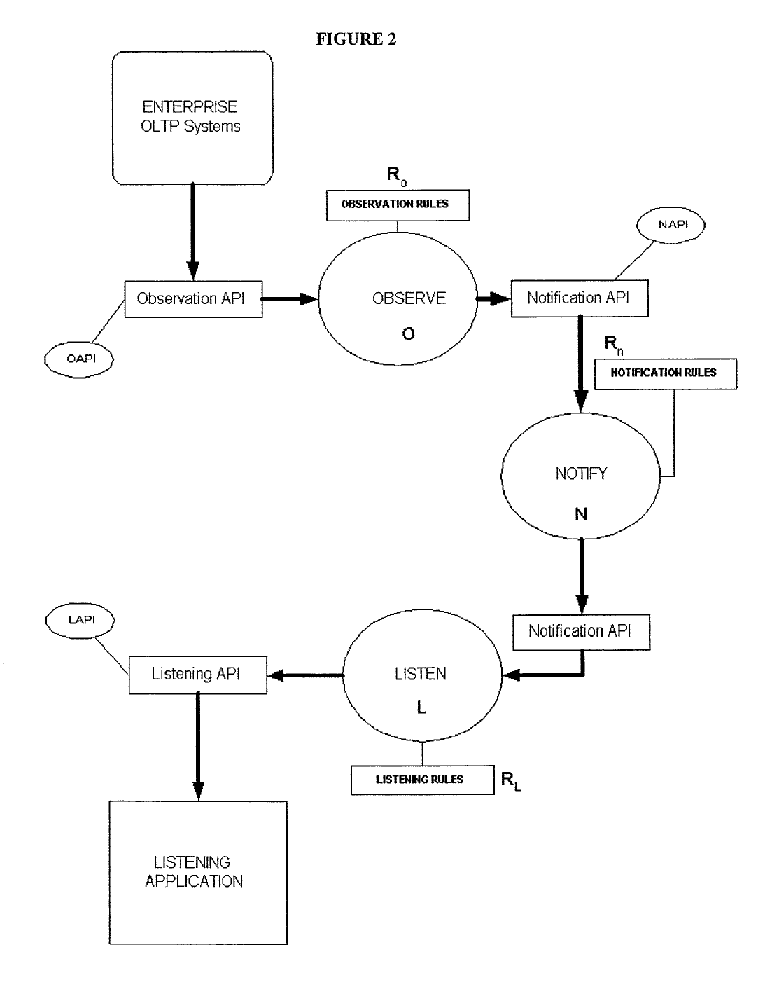

A logical diagram showing the key elements required for the observation agent architecture of the present invention is shown in FIG. 2.:

1) Observation rules Rₒ determine what is to be observed by the observer

2) Notification rules Rₙ determine what the observer passes on to one or more listeners

3) Listening rules R_{L} determine what to filter out before passing information on to the analysis engine.

As shown in FIG. 2, the software observer agent (O) observes data events (observations) according to observation rules Rₒ. The notification component (N) then takes on these observations and puts them in the mailboxes of the listeners according to the notification rules Rₙ, which relate to mailbox management. (Note that when the term “mailbox” or “mail” is used, the reference is not to e-mails as such, but rather to notification generally.) The listener (L) is a client side component, which after having established a connection to the relevant listener (L) provides the listening rules R_{L} to the notification agent (N), which is used to customize the observation delivery to the mailbox of the listener (L). After that the listener (L) can access the mailbox in a connected or disconnected mode as and when required. Typically, each of the software observer agents resides on a server computer with one observer agent associated with each database. In addition, the notify agents also reside on the server computers. Each of the listener agents however resides on a client computer with the client computers and the server computers connected by a communication network (such as intranet or internet).

Following are the key benefits this platform provides:

Reduced Need for Wholesale Data Management and Analysis

Rather than analyze data in bulk, observation agents simply observe changes in key metrics (also known as “states”) and report back on these changes in real time; thus the quantity of data being leveraged never increases

Formal Infrastructure to Manage Pervasive Just-in-Time Enterprise Information

The platform provides a means to create, modify, catalog, query, deliver and manage observations. An analogy: just as various clients have a consistent view of the data from a DBMS, so the observation management system provides a consistent view of relevant observations from diverse sources to a client.

Rapid Integration of Observed Data

The platform provides a consistent Application Program Interface (API) to discover and define the data assets to be observed. Once the adapter is provided for a specific data source type, the observation console can declaratively configure and install an observation agent and manage its life-cycle without any programming effort.

Efficient Flow of Information

Since different applications would have different requirements for the observations, a rule based filtering mechanism coupled with composite observing capability would eliminate redundancy and would thus reduce the load on the observed data source. Also these observations can be mixed, matched and transformed via formal semantic rules, to create much higher order of knowledge, which can then be pro-actively delivered to the observing application.

Rule Based Observations

Filtering and transformation rules, both at the observation and listening end would enable applications to dynamically change observation behavior.

Agent-based Observations

Observation agents will have the characteristics required from software agents of being context sensitive, non-intrusive and proactive. This will be achieved by leveraging on existing infrastructure provided by data sources wherever possible.

Integration of Data Management and Analysis with Business Decision-making in a Seamless Whole

Observation agents observe changes in key metrics; these changes are tied to business decisions via business rules; decisions are thus automated in real time.

Self-adaptation Via a Closed Feedback Loop

The present invention is uniquely self-adapting; customer models are continuously measured against empirical data and improved accordingly; predictive hypotheses are tested and refined—all in real time, via a closed feedback loop.

Ease of Integration

The present invention is a “light footprint” technology, quick and easy to install (unlike current information management systems, which can take years to implement and are in fact never completed).

Compatibility with Existing Information Infrastructure

The invention adds a layer on top of existing standard platforms like EJB, XML, JDBC, JMS, etc., to provide an integrated solution for observation integration.

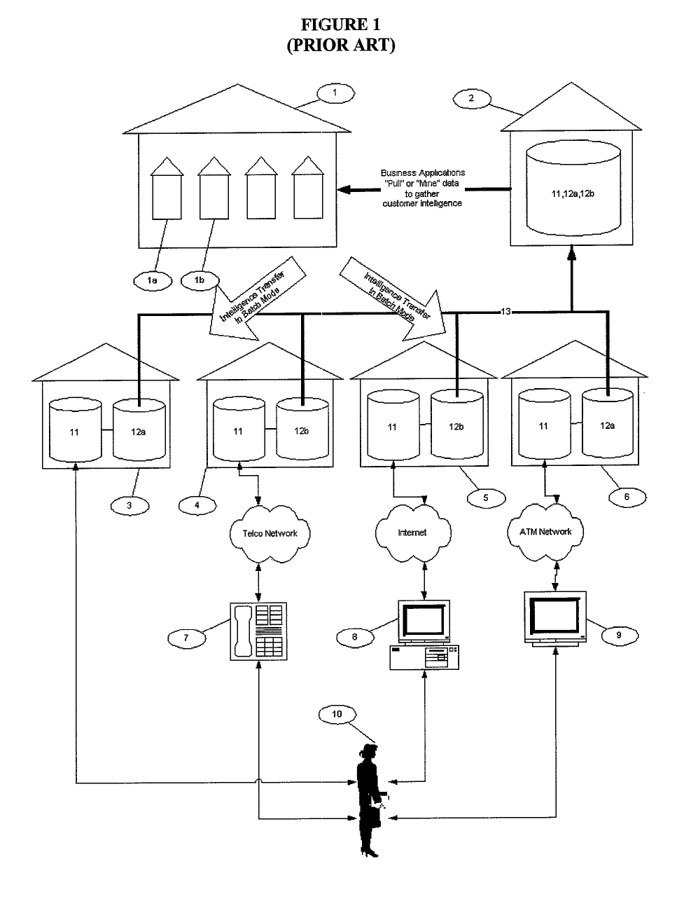

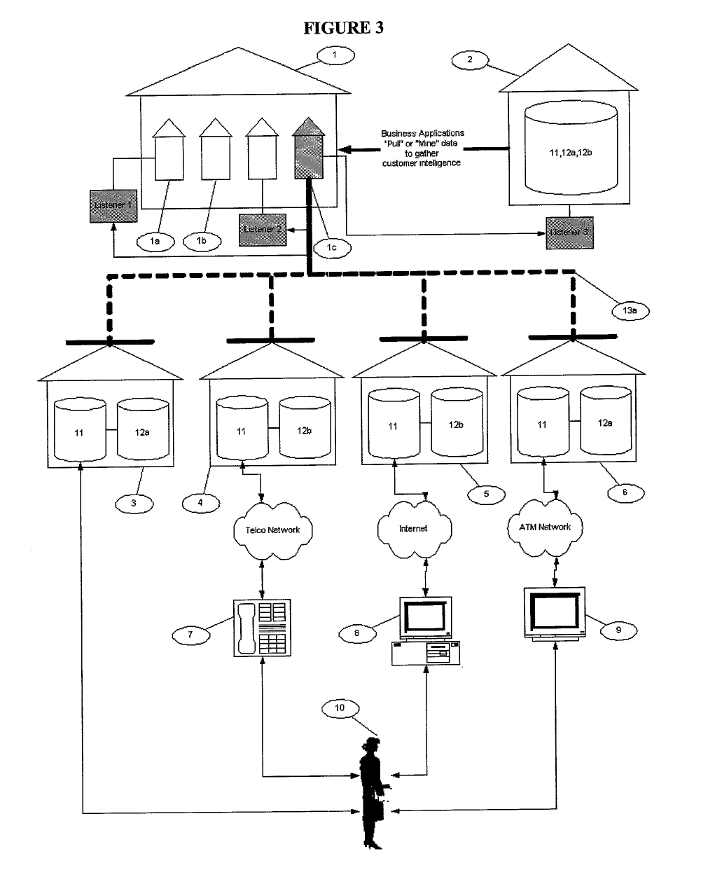

An example of the application of the present invention to the prior art system shown in FIG. 1, is shown in FIG. 3.

### I. OPERATING ENVIRONMENT

Customer Interaction Data Sources

In FIG. 3 customer 10's and client 1's interaction data sources are a heterogeneous combination of touchpoint-specific, type-specific, platform-specific entities, distributed across the client's enterprise (and usually also geographically). This environment is characterized by:

Multiple touchpoints (Branch Office 3, Call Center 4, Web Site 5, ATM Machine 6, 9), for both customer information 11 and transactional interaction 12a, 12b

The various touchpoints are accessed via various mechanisms, both human and machine-based, e.g., walking to branch 3; using the telephone 7 to access call center 4; or using PC 8 to access the Internet

Each touchpoint is a data source of potentially various types (Relational Database 12b, flat file 12a, Application 12, etc.)

Each data source type can reside on a particular platform, typically a server computer such as IBM DB2/Unix, SQLServer/NT, etc.

The data from multiple touch points (3,4,5,6) are communicated via a communication path (intranet or internet) through observation agents 13a to the central information-processing center 2, where it is stored and possibly “mined” to glean any relevant intelligence, which is then fed to the client's headquarters 1.

Customer interaction data is interactive and “full duplex,” meaning that both informational (web content, promotions, etc) and transactional data (account information, etc.) are put into—and in other cases retrieved from—the data sources. However, significantly more data is put into the systems than is retrieved from them because the act of retrieval is itself recorded and stored. In effect, from a data collection and recording perspective, this interaction is a continuously growing “collection” of data.

Once the data is stored in the Central Processing Center 2, businesses want to benefit from any intelligence derived from the interaction, so a whole host of applications emerge to facilitate transformation of this continuously collected data into useful business intelligence, usually in a batch mode (nightly, monthly, etc.). This process is loosely termed “mining,” hence the applications are typically called “data mining” applications. The basic function of these applications is to “extract” intelligence from past data. This extraction process is represented as an arrow in FIG. 3 from Center 2 to headquarter 1.

Once mined, the business intelligence uses Business Units 1a and 1b to create or modify business rules that form the basis of various decisions typically distributed across several functional areas of the financial enterprise. This process of “pushing” out the intelligence to the various operations decision points is known as “operationalizing” intelligence. Several applications operate in this context, all “using” this intelligence to positively “impact” the interacting customers and possibly increase the value of future interactions. This is also shown in thick arrows in FIG. 3 flowing outward from the headquarter 1.

### II. OPERATION

The invention is a software program comprising a central manager (main program) and several “agent” modules (or sub-programs). In the preferred embodiment, the main program is written in JAVA and executes on any hardware that contains a JAVA. The agent modules are written in JAVA.

Observation Agents

One Observation Agent may exist for each data source in the enterprise. Thus, for example, an Observation Agent is associated with each server computer containing a database.

Notification Agents

Only one notification “directory” exists that may have several notification agents within it, one for each observation agent. The notification directory is a brokering and naming service accessed by the observations, the listeners, and an administration console.

Listening Agents

A listener is a business application specific program that houses the “business application rules” for each business application. One listener exists for each business application that wants to use it.

FIG. 3 shows the physical location and placement of the Observation Platform in an existing enterprise information system. The information adapters 13 in FIG. 1 are now replaced, in FIG. 3, by the observation agents 13a, and the business enterprise 1 now houses a new “observation administration station” shown as 1c.

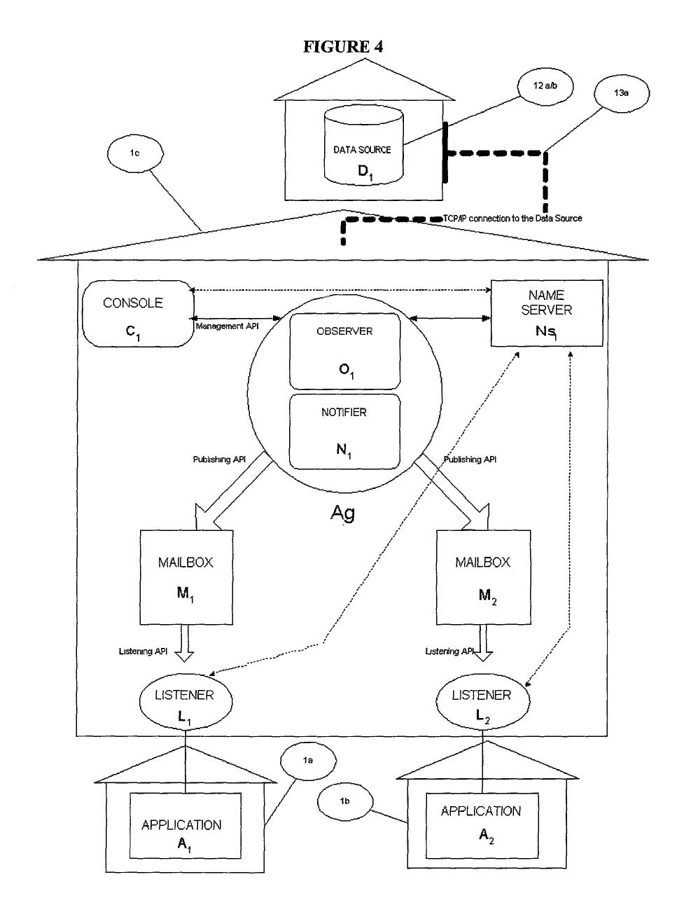

FIG. 4 expands upon the details of the “observation administration station” 1c (top left) and information adapters 13a (top right) by showing the key architectural elements of the invention as integrated into an enterprise information system.

For purposes of explanation, a real-life scenario is provided, involving a representative enterprise application—in this case, a cross selling application in the banking sector, where bank A aims to improve on credit card marketing to its existing checking account customers.

In the following, it is important to distinguish between 1) business application logic, and 2) Observation Platform Rules (Observation rules, Notification rules and Listening rules). For example, the business application logic for offering a credit card for this purpose is as follows:

“if the account balance falls below a thousand dollars, and the customer has been there for more than five years, and their fico score is above 550, then offer the credit card in California”

To support this business application logic, the following observations are relevant:

Account Balance

FICO credit score

Length of membership in California

The “Observation Platform Rules” allow filtering to achieve this relevancy in observation by observing only those fields relevant to the business application served. As shown in FIG. 3 (and, at a higher level of abstraction, in FIG. 2) the observer (O) observes the data events (observations) according to observation rules Rₒ, (e.g., an observation rule might be to observe the customer's account balance and FICO credit score for bank customers residing in California). The notification component (N) then takes on these observations and puts them in the mailboxes of the listeners according to the notification rules Rₙ, which relate to mailbox management. The listener (L) is a client side component, which after having established a connection to the relevant listener (L) provides the listening rules R_{L} to the notification agent (N), which is used to customize the observation delivery to the mailbox of the listener (L), e.g. notify only when the account balance drops by more than 20% (new:account_balance<old:account_balance*0.80). After that the listener (L) can access the mailbox in a connected or disconnected mode as and when required.

### Observation Agent

The observation agent (O) 13a is the system component that captures the observation and makes it available to the observation subscribers. The Observation Agent consists of two logical components: an observation component and a notification component. Both components are configurable either via console or via a configuration file (see III. Administration, below). This is primarily a demon-like process, which registers itself with the “Observation Agent Repository” while it boots up and starts performing observations on the data source. The observations are then analyzed and transformed by the notification component and delivered to the mailbox of the subscribers.

In our example, let there be a customer data (FIG. 4, D₁) in an OLTP system for bank called “Virtual Bank of USA”. The California office has a requirement that any time the customer cash withdrawals are more than $1000 a day, some specific action needs to be taken. The system administrator creates an observation to observe the account balance which includes the time the transaction happened, the fields to be observed, the time period for which the observation is valid, the access rights for the observation, and makes the application in California office (FIG. 4, A₁) a subscriber to this observation on its request. The notification agent (FIG. 4, N₁) would deliver the observations in the mailbox (FIG. 4, M₁) of the California office with an added rule that the observations life span is two days, after which, the observations would automatically be cleared off by the notification agent (FIG. 4, N₁).

### Notification Agent

The notification agent (FIG. 4, N₁) forms the basis for all outbound data observation packets. Logically a separate entity, physically notification agent resides along with the observation agent. The notification agent provides an interface to register listeners. It also provides a mailbox metaphor for messages to be delivered and persisted. It allows for discriminator rules for notification based on observed attributes. The Notification subsystem abstracts out the connectivity for outbound observed data from the observation agent (FIG. 4, Ag). The Publishing API (FIG. 4, Publishing API) would be the interface used by the notification agent (FIG. 4, N₁) to provide the above notifications to the listener (FIG. 4, L₁). The publishing API will allow the agent to set up mailboxes (FIG. 4, M₁, M₂) for listeners and do the clean up for observations from the mailbox as desired.

In our example, the publishing APIs would let the observation agent (FIG. 4, Ag) set the mailbox (FIG. 4, M₁) for the California office (FIG. 4, A₁), assign it a lease, and enable the agent to publish the observations to be observed by the listening application (FIG. 4, A₁). Following the example, the notification agent would let an observer i.e. the Virtual Bank Application to precisely specify what attributes it is interesting in observing via the notification rules (FIG. 2, R_{N}) and the observation agent (FIG. 4, Ag) would set up the mailbox (FIG. 4, M₁) for the above application.

### Observation API

The Observation API (FIG. 2, Observation API) forms the basis for all in-bound data observation packets. This API abstracts out the connectivity for inbound observed data to the observing agent. Observation API constitutes a consistent interface for a listener to receive the observations by enabling it to consistently connect to the observation platform. This API would let the listener set the listening rules, e.g. in the example above the application for California could set the rule to listen only to observations related to California.

In the above example of “Virtual Bank” the API would let the listener rule (FIG. 2, R_{L}) sum(withdrawals)>1000 on SAME(DAY) NOTIFY and will notify the application at the California office (FIG. 4, A₁) of all accounts where the sum of withdrawals exceeded one thousand dollars. Now this application can be a continuously running application whereby anytime a withdrawal is made the above condition is tested, in which case the listener (FIG. 4, L₁) acts as a second tier agent, or it can be just a simple batch application run at the end of the day to flag the accounts which satisfy the above condition. In our example, this would mean that the observations can be delivered at the end of the business day, and the application while processing the observation can either decide to do the sum of withdrawals themselves or can delegate it to another agent to flag out accounts where the sum of account balance exceeded one thousand dollar mark.

### Management API/Observation Console

Primarily used by observation console to do agent management. The Observation Management Console (FIG. 4, C₁) and other third-party administrative applications use the Management API to configure, manage, discover, and monitor the smooth working of the observation management platform.

In the example above, the API would let the system integrator, using the console (FIG. 4, C₁, which is an application written using the management APIs), to set up the observation if it does not exist; or edit the observation if it does exist but does not serve the purpose of the California office. Once the observation agent has been registered in the name server (FIG. 4, Ns₁), the API can keep track of the health of the agent via some heart beat mechanism. The heart beat mechanism can usually be a periodic packet based communication with the name server (FIG. 4, Ns₁) to let the system be aware of the health of the agent (FIG. 4, Ag).

### Listener

The Listener provides an API to discover, connect and poll observations; a toolbox for authoring discrimination rules (also referred to earlier as business application logic) to filter observed data based on attributes in the data; and an interface to transform observation data into useful business intelligence.

Listener (FIG. 4, L₁) is the logical end point of the agent platform, which provides the adapter 13a for the observing applications (FIG. 4, A₁). The listener provides APIs (FIG. 4, Listener API) to discover, connect and poll observations. It also provides the discriminator rules (FIG. 2, R_{L}) to filter observed data based on attributes in the data. It also provides an interface to transform observations to suit the purposes of the observing application (FIG. 4, A₁). This module constitutes the proxy (a proxy is a pattern frequently used for distributed applications) for the listening application and provides a seamless plug-ability for diverse listening applications. What this implies is that a listening application (FIG. 4, A₁) can dynamically decide to use the listening services from the observation platform.

In the example above the listener (FIG. 4, L₁) would be the California office application (FIG. 4, A₁), which will use the listening APIs to discover, connect and listen to the required observations. In our example, the customer data (FIG. 4, D₁) for “Virtual Bank of USA” is being observed. The California office has a requirement that any time the customer cash withdrawals are more than $1000 a day, some specific action needs to be taken. The system administrator creates an observation to observe the account balance which includes the time the transaction happened, the fields to be observed, the time period for which the observation is valid, the access rights for the observation and makes the application in California office (FIG. 4, A₁) a subscriber to this observation on its request. The notification agent (FIG. 4, N₁) would deliver the observations in the mailbox (FIG. 4, M₁) of the California office with an added rule that the observations life span is two days, after which, the observations would automatically be cleared off by the notification agent (FIG. 4, N₁). The notification agent would let an observer (in this case the Virtual Bank Application) know, via the notification rules (FIG. 2, R_{N}), precisely specify what attributes it is interested in observing, and the observation agent (FIG. 4, Ag) would set up the mailbox (FIG. 4, M₁) for the above application. These observations can be delivered at the end of the business day, and the application, while processing the observation, can decide either to do the sum of withdrawals themselves or delegate it to another agent to flag out accounts where the sum of account balance exceeded one thousand dollar mark.

### Observation Management Console

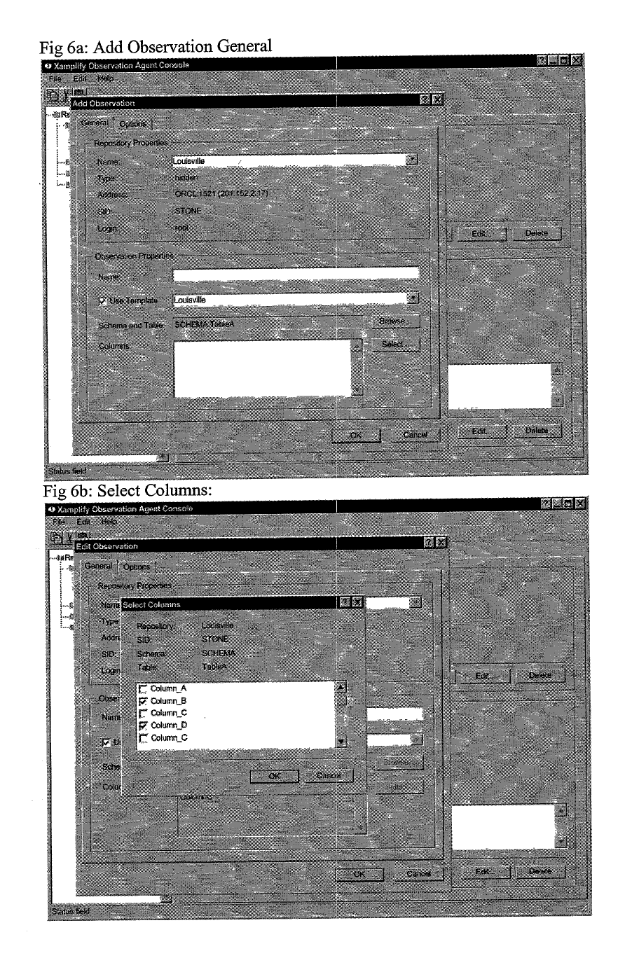

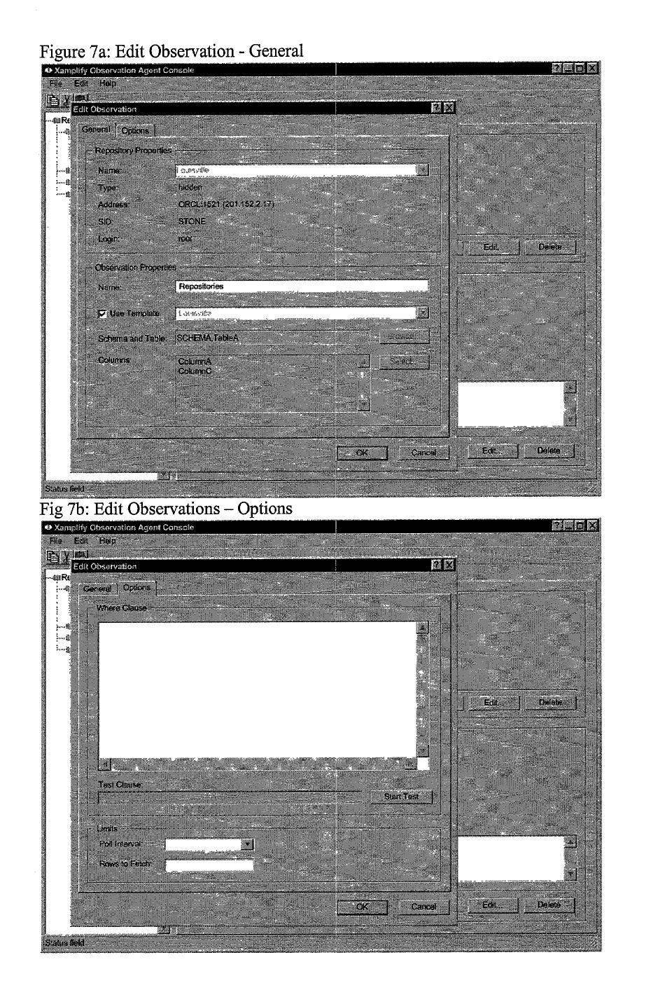

The Observation Management Console (FIG. 4, C₁) acts as the nerve center for the distributed agents. It will monitor, manage, and co-ordinate the agents. The management console would be used to discover the observable entities (for the UI description of how this will be achieved in the proposed system please see FIG. 6a). In the checking account application and data and would provide an observation administrator to choose the account balance as an attribute to be observed (FIG. 6a, FIG. 6b) along with rules to view only California and Nevada customers (FIG. 7b, “Where Clause”). The Console would let the administrator set the quality of observation requirements (FIG. 7b, “Poll Interval” and “Rows to Fetch”)—e.g., what to observe, and how often, and for how long. Once defined the console would create the required observation information that can then be used by an agent to start an observation.

In the example the Observation Management Console (FIG. 4, C₁) will let the observation administrator discover the data source (FIG. 4, D₁), give the administrator the ability to discover the observed attribute “Account Balance” within the data source (FIG. 4, D₁) and will then will let the administrator set the observation rules e.g. in this can be the observation rule to observe customers residing in California (state=‘CA’) (FIG. 2, Rₒ). Once the information is provided to the observation console (FIG. 4, C₁) it will set up the observation agent (FIG. 4, Ag), which can then be started automatically or at a later time.

Once the agent has been up and running, the observation console (FIG. 4, C₁) will be used to administer, modify and remove the agents as and when required.

### Observation Agent Repository

This is the naming service for discovery and description of agents. This can be evolved to use Universal Description, Discovery and Integration (UDDI: a universal standard for Web Services model) or some other standard to fit into the overall web services architecture. The observation Agent repository acts as a naming and directory service where the observing applications can query for and get the address for the relevant observation available to the application. The application can then enable listening to the observation.

The Observation Agent repository in our scenario would hold the observation agent (FIG. 4, Ag) names and its observation properties e.g. what is being observed (the attribute list, FIG. 6b), how often is it being observed (Polling interval, FIG. 7b “Poll Interval”), and what are the conditions to be satisfied before the observation takes place (observation rules, FIG. 7b “Where Clause”) such that when the California office requires Athe same observation (FIG. 4, Ag) it can send a query to the Observation agent repository (FIG. 4, Ns₁) if it can service the request and if it can, request for the agent (FIG. 4, Ag) address which could be a URL or a TCP/IP port.

The naming service provides various mechanisms to search and query the required agents based on its properties. The repository also keeps track of the health status of the agents and can be used by the observation administrator using the Observation management console (FIG. 4, C₁) to do observation platform management.

### Observing Application

An observing application (FIG. 4, A₁) is an external application which uses the observation management platform to proactively access the events (observations) as and when they occur according to pre-defines quality of service rules defined in the observation platform in the form of observation rules (FIG. 2, Rₒ), notification rules (FIG. 2, Rₙ) and listening rules (FIG. 2, R_{L}). The observing application is provided with an interface in the form of Listener API, which allows it to “plug” into the observation platform. This is accomplished via first discovering the relevant observation agent, making a connection to the agent, notifying it of its listening requirement and getting a handle for its mailbox (FIG. 4, M₁) for subsequent listening.

In the example provided, the California office application (FIG. 4, A₁) is the observing application. The only awareness it has of observable events is the name service (FIG. 4, Ns₁). It connects to the name service and sends a query to the name service asking for agent addresses which can provide it customer account balance changes in the Data source (FIG. 4, D₁). The name service returns the address of the agent (FIG. 4, Ag). The application (FIG. 4, A₁) uses this address to connect to the agent, and requests for the required observations. In response the agent notification service (FIG. 4, N₁) creates a mailbox for the listening application (FIG. 4, A₁) and sends back the address of the mailbox to the application. After which the application start receiving the required observations to be acted upon.

### III. ADMINISTRATION

An example is provided to illustrate the administration process: A loan officer for a financial services company wants to obtain the current credit card balance, APR rate, FICO score and credit limit/line of each customer whenever a customer submits an application for a personal loan. The officer logs in to the system and first finds out (by querying the yellow pages of the naming service directory) if an existing agent is already submitting the above information for the above customer. If so, he creates another listener for the agent for the above information. If not, then he creates an observation that sends his application (or desktop) the above information with a screening clause that triggers this event when the customer's “loan apply” flag is set to 1 (from 0).

Data Discovery

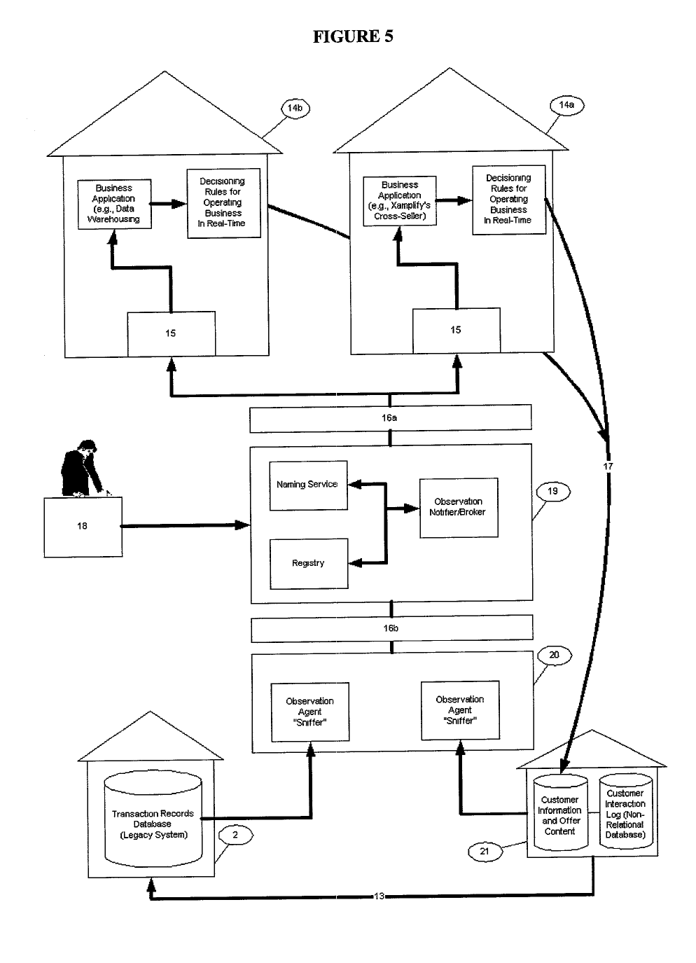

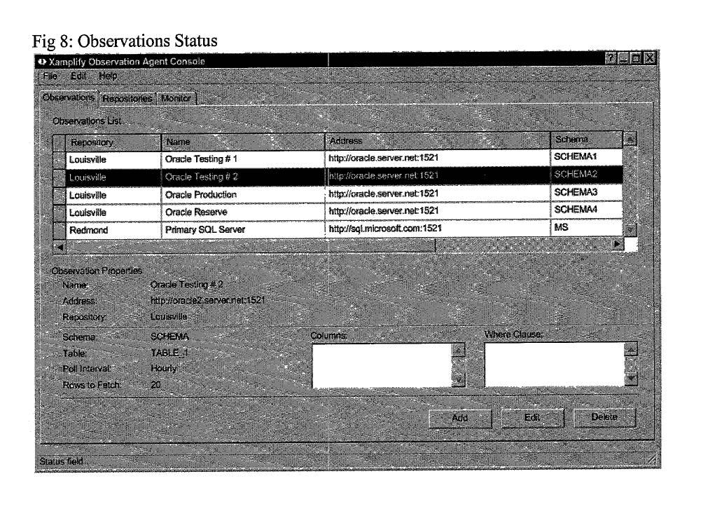

As FIG. 5 shows, the user logs into the agent platform using the same administrative console 18 and then queries the registry for a list of all data sources known to the system. He then queries the registry, using the naming service, for a list of all agents currently observing the object of interest. This process is termed “data discovery” and its main purpose is to allow the user to re-use an existing observation already in place or to clone and modify one for a special purpose. This is shown in FIG. 7a and FIG. 7b. Only when these two cases fail to deliver the data that the user wants does the user either create a new observation on a registered data source or request the installing administrator to install the platform at another data source location. To view all the observations currently in progress, the user can either search the naming services for key names for observation attributes or list all the observations and select one as shown in FIG. 8.

Start From Scratch and Create/Activate an Observation

Once the user has discovered the relevant data, he starts or creates a new observation using an existing data source. FIG. 6a and FIG. 6b show this console functionality. The observation console informs the user of the various tables available to be observed and the various entities (and their attributes) like field names, field types, field size, etc., that are available to the user to help create and start an observation. Using this console, the user selects the entities of interest to him (that is, to his application) and “creates” an observation by assigning a unique name (conforming to the naming service) and a schedule (real-time, hourly, nightly, etc.). After creating this entity—called the observation—the user then activates it.

Clone and Modify to Create/Activate an Observation

Especially after the observation platform has been in usage for an extended period of time (e.g., several months) enough observation agents are already in place that only slight modifications are usually needed for new applications. So, cloning an existing observation and then modifying the clone is a much more efficient means to create and activate new observations. The steps involved are shown in FIG. 7a and FIG. 7b, and are identical to the above except preceded by the user cloning an existing observation and using the clone for all subsequent steps (some of these are mentioned in the following section of changing the observation).

Edit/Change/Inactivate an Observation

Typically, due to the growing, evolutionary needs of the application or to fix some problem (or in the case above to create an observation through modification of an existing observation's clone), it is required to modify an existing observation. To do this, as shown in FIG. 7a and FIG. 7b, the user logs into the console and selects the observation that needs to be changed. The user first deactivates the observation and then “opens” it to edit. The user than makes any changes to the observation (name, schedule, etc.), saves the changes and then re-activates the observation.

What is claimed is:

1. A method of processing information from a plurality of distributed databases by a software application program, said plurality of distributed databases and said software application program connected by a communication network, said method comprising:
assigning a plurality of software observation agents to said plurality of distributed databases with one software observation agent assigned to a different one of said plurality of distributed databases; each of said software observation agents operating under an observation rule to detect changes in its associated database;
operating under said observation rule by each of said plurality of software observation agents to notify a plurality of software notify agents, via said communication network; each of said software notify agents operating under a notifying rule to notify a particular software listening agent; and
operating under said notifying rule by each of said plurality of software notify agents to transmit a notification to a software listening agent, via said communication network; said software listening agent for supplying said notification to said software application program;
wherein said software application program is responsive to changes detected in the plurality of distributed databases.

2. The method of claim 1 wherein said software listening agent operates under a listening rule to filter said notification, prior to supplying said notification to said software application program.

3. The method of claim 2 further comprising:
operating said software application program based upon said filtered notification from said software listening agent.

4. The method of claim 1 wherein each of said software observation agent, notify agent and listening agent is a JAVA program.

5. A method of operating a software application program in response to changes in data from a plurality of distributed databases, said method comprising:
detecting changes in data from said plurality of distributed databases by a plurality of software observation agents, with one software observation agent assigned to a different one of said plurality of distributed databases; with each of said software observation agents operating under an observation rule;
notifying a plurality of software notify agents by said plurality of software observation agents, in response to operating under said observation rule;
operating under a notifying rule by each of said plurality of software notify agents to transmit a notification to a software listening agent;
supplying said notification to said software application program by said software listening agent, operating under a listening rule;
wherein said software application program is responsive to changes in data from said plurality of distributed databases.

6. The method of claim 5 wherein said plurality of distributed databases and said software application program are connected by a communication network, and wherein said plurality of software observation agents, and said plurality of notify agents, and said listening agent communicate via said communication network.

7. A database management system comprising:
a plurality of server based computers having a plurality of distributed databases for storing data;
a client based computer for operating a software application program;
a communication network connecting said plurality of server based computers and said client based computer;
a plurality of software observation agents, with one software observation agent assigned to a different one of said plurality of distributed databases for detecting changes in said data in the associated database; each of said software observation agent having an associated observation rule, and for generating an observation in response thereto;
a plurality of software notify agents for receiving said observation from said plurality of software observation agents, each of said plurality of software notify agents having an associated notify rule and for generating a notification in response thereto communicated over said communication network; and
a software listening agent for receiving said notification from said plurality of software notify agents via said communication network; said software listening agent having an associated listening rule for filtering said notification and for notifying said software application program.

8. The system of claim 7 wherein said plurality of software observation agents are operable by said plurality of server based computers.

9. The system of claim 8 wherein said plurality of software notify agents are operable by said plurality of server based computers.

10. The system of claim 9 wherein said software listening agent is operable by said client based computer.

11. The system of claim 10 wherein each of said plurality of software observation agents and each of said plurality of notify agents and said software listening agent is a JAVA program.

12. The system of claim 7 further comprising,
user input consol for changing said observation rule.

13. The system of claim 12 wherein said user input console for changing said notify rule.

14. The system of claim 13 wherein said user console for changing said listening rule.

15. A computer product for use with a database management system including a plurality of server based computers having a plurality of distributed databases for storing data, a client based computer for operating a software application program, and a communication network connecting said plurality of server based computers and said client based computer; said computer product comprising:
computer usable medium having computer readable program code embodied therein for use with said plurality of server based computers for causing a plurality of software observation agents assigned to said plurality of distributed databases, with one software observation agent associated with a different one of said plurality of distributed databases for detecting changes in said data in the associated database; each of said software observation agent having an associated observation rule, and for generating an observation in response thereto communicated over said communication network;
computer usable medium having computer readable program code embodied therein for use with said plurality of server based computers for causing a plurality of software notify agents which receive said observation from said plurality of software observation agents, each of said plurality of software notify agents having an associated notify rule and for generating a notification in response thereto communicated over said communication network; and
computer usable medium having computer readable program code embodied therein for use with said client based computer for causing a software listening agent for receiving said notification from said plurality of software notify agents via said communication network; said software listening agent having an associated listening rule for filtering said notification and for notifying said software application program
